(19) United States
(12) Patent Application Publication
(10) Pub. No.: US 2016/0049710 A1
(43) Pub. Date: Feb. 18, 2016

(54) THREE DIMENSIONAL TUNABLE FILTERS WITH AN ABSOLUTE CONSTANT BANDWIDTH AND METHOD

(71) Applicants: Fengxi Huang, Waterloo (CA); Siamak Fouladi Azarnaminy, Waterloo (CA); Mitra Nasresfahani, Waterloo (CA); Raafat R. Mansour, Waterloo (CA)

(72) Inventors: Fengxi Huang, Waterloo (CA); Siamak Fouladi Azarnaminy, Waterloo (CA); Mitra Nasresfahani, Waterloo (CA); Raafat R. Mansour, Waterloo (CA)

(21) Appl. No.: 14/828,143

(22) Filed: Aug. 17, 2015

Related U.S. Application Data
(60) Provisional application No. 62/038,549, filed on Aug. 18, 2014.

(51) Int. Cl. H01P 1/20; H01P 11/00; H01P 7/10

(52) U.S. Cl. CPC H01P 1/2002; H01P 7/10; H01P 11/006; H01P 11/007

(57) ABSTRACT

A tunable bandpass filter to provide a constant absolute bandwidth across the entire tuning range. The filter comprises of a plurality of tunable resonators, each having an enclosure. A resonating structure extending upwardly from the bottom surface of the enclosure and a tuning screw with a flat head extending downwardly from the top surface of the enclosure, wherein the resonating structure and the flat head of the screw face each other and form a gap. The height of the tuning screw can be adjusted to change the gap between the resonating structure and the flat head. The adjustable gap of the present filter allows for tunable filter operation.

### RELATED APPLICATION

The present application claims the priority date of provisional patent application No. 62/038,549 filed Aug. 18, 2014.

### FIELD OF THE INVENTION

The present invention relates to three dimensional (3D) microwave filters and method, and, in particular embodiments, to a tunable bandpass filter with an absolute constant bandwidth over the tuning range.

### BACKGROUND OF THE INVENTION

3D resonator filters such as cavity combline, dielectric resonator and waveguide filters are widely used in wireless communication applications due to their superior performance in terms of high quality factor (Q-values) and high power handling capability. Several frequency bands are utilized simultaneously in wireless base stations to support different wireless standards. Each frequency band requires the use of bandpass filters to suppress unwanted signals and avoid the interference from adjacent bands. Using the conventional method, several bandpass filters are required to be installed in a base station to meet such requirements. Moreover, any upgrade of the network to accommodate a new standard, will require the addition of new filters to the base station. The availability of tunable/reconfigurable hardware helps to reduce the base station size by reducing the number of filter elements, it also provides the network operator the means for efficiently managing hardware resources, while accommodating multi-standards requirements and achieving network traffic/capacity optimization. Tunable filter also allows a base station to be upgraded for future wireless standards without any need for installation of new filters.

In order to minimize the number of tuning elements and to improve the loss performance of the tunable filter, it is preferable to use tuning elements only to tune the resonator center frequencies. However, the variation of inter-resonator coupling with frequency is different from that of the input/output coupling. This in turn results in deterioration of the filter return loss and changes in the filter absolute bandwidth over the tuning range. One possible solution is to add tuning elements to control the inter resonator coupling and the input/output coupling as well. In many cases, this solution may not be even feasible because of size limitation, design complexity and the inherent difficulty to tune sequential and cross inter-resonator coupling. Therefore, one needs to use only tuning elements for the resonators to tune their frequency.

This invention discloses a design method and structure of a 3D tunable bandpass filter, which avoids complex structures and provides a constant absolute bandwidth with thorough use of tuning elements only for the resonators.

### SUMMARY OF THE INVENTION

In one embodiment of the present invention, a constant bandwidth tunable bandpass filter is provided. The filter comprises of tunable resonators with tuning screws or piezoelectric motors as the tuning elements. The filter also comprises of inter-resonator and input/output coupling structures that do not require any tuning elements in order to maintain an absolute constant bandwidth while tuning filter's center frequency. The tuning elements for the resonators could be based on mechanical screws, motors, ElectroMechanical Systems MEMS, semiconductor, ferroelectric materials such Barium Strontium Titanate (BST) or any other tuning mechanism.

In another embodiment of the present invention, a method of designing a tunable bandpass filter is provided. The method comprises of forming tunable resonators with tuning screws or piezoelectric motors and a resonating structure. The method also comprises of a balanced electromagnetic coupling scheme between resonators and also input/output couplings that does not require tuning elements.

### BRIEF DESCRIPTION OF THE DRAWINGS

For a complete understanding of the present invention and the design procedures, reference is now made to the following descriptions taken in conjunction with the accompanying drawing, in which:

FIG. 1 is a perspective view of an embodiment of a 4-pole tunable bandpass filter;

FIG. 2 is a perspective and cross section view of an embodiment of a tunable resonator employed in the filter of FIG. 1;

FIG. 3 is a perspective view of a pair of coupled resonators and cross section view of an embodiment of the balanced electromagnetic coupling structure between the resonators in the filter of FIG. 1;

FIG. 4 is a graph illustrating tuning of the even and odd mode resonance frequencies and variations in the balanced coupling value for optimized dimensions of the coupling structure in FIG. 3;

FIG. 5 is a perspective and cross section view of input/output couplings used in the filter of FIG. 1;

FIG. 6 is a graph illustrating variations in the group delay for an optimized length of coupling probe in FIG. 5 and when the resonance frequency of the resonator is tuned;

FIG. 7 is an embodiment of the four pole tunable bandpass filter with a constant bandwidth with tuning screws;

FIG. 8 is a graph illustrating measured S-parameters for an embodiment four-pole filter in FIG. 7;

FIG. 9 is an embodiment of the four pole tunable bandpass filter with a constant bandwidth with piezoelectric motors;

FIG. 10 is a graph illustrating measured S-parameters for an embodiment five-pole filter and for an embodiment seven-pole filter fabricated using the disclosed tunable filter design method; and

FIG. 11 is a flowchart illustrating an embodiment of a method of designing the filter of FIG. 1.

### DETAILED DESCRIPTION OF ILLUSTRATIVE EMBODIMENTS

The making and using of the present embodiments are discussed in detail below. It should be appreciated, however, that the present disclosure provides many applicable inventive concepts that can be embodied in a wide variety of specific contexts. The specific embodiments discussed are merely illustrative and do not limit the scope of the disclosure.

The present disclosure will be described with respect to a specific context, namely a wireless communications system that supports communications devices with data capability, i.e., third-generation (3G) and fourth-generation (4G) communications devices. The concepts of the present disclosure may, in general, be applied to wireless communications systems that support data capable communications devices.

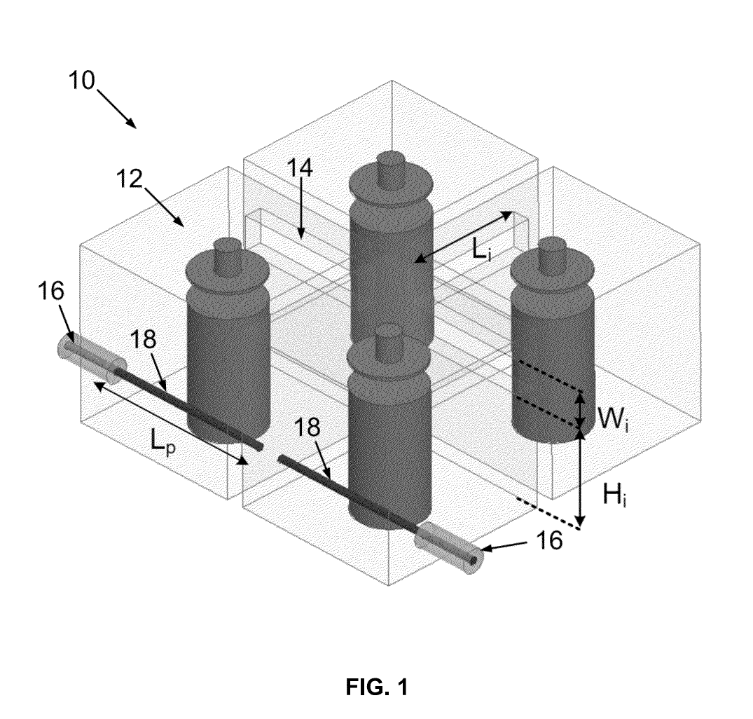

Referring now to FIG. 1, an embodiment of a tunable bandpass filter 10 (e.g., a radio frequency (RF) front end filter) is illustrated. Tunable filter technology is an integral part of wireless base station size and cost reduction. As will be more fully explained below, the filter 10 generally permits a wireless infrastructure provider to reduce the number of filter products being managed, with less logistic management complexity. The filter 10 also enables wireless service providers to reconfigure their networks through software upgrades, including remote software upgrades. In an embodiment, the filter 10 is smaller in size and weight than traditional filter banks, yet is less expensive to produce and operate relative to conventional filters. In addition, the filter 10 has a wide tuning range and has a constant absolute bandwidth over the entire tuning range. The filter 10 is also applicable to a wide frequency range. Therefore, the filter 10 has worldwide application to many different wireless systems. The filter 10 operates over a wide tuning range while the filter bandwidth remains constant across the entire tuning range.

As shown in FIG. 1, the filter 10 comprises of poles or tunable resonators 12, a coupling structure 14, input/output ports 16, and input/output probes 18. In FIG. 1, the filter 10 contains four tunable resonators 12. However, in other embodiments, the filter 10 may include a plurality of tunable resonators 12 (e.g., two, three, four, five, six, or more).

The coupling structure 14 permits the tunable resonators 12 to be operably coupled to each other. In an embodiment, the coupling structure 14 is designed to provide a balanced electromagnetic coupling with a constant normalized value. The input and output ports 16 permit the filter 10 to be incorporated into a wireless communication device (e.g., a time division duplexing (TDD) base station, another type of base station employing filters, etc.) or operably connected to other telecommunications devices. By way of example, the input port 16 may be coupled to an antenna and the output port may be coupled to a power amplifier. In an embodiment, the filter 10 comprises input/output probes to provide constant input/output coupling values while the filter center frequency is tuned.

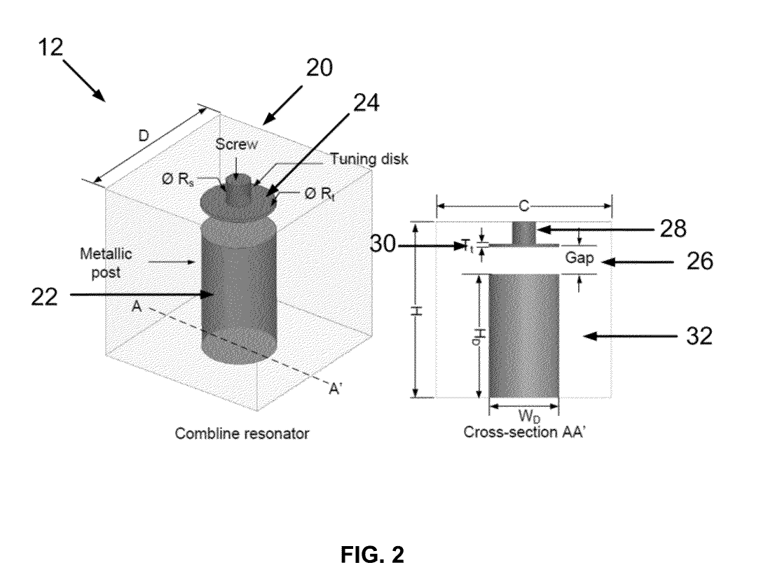

Referring now to FIG. 2, a cross section of one of the tunable resonators 12 from the filter 10 of FIG. 1 is illustrated. As shown, the tunable resonator 12 comprises a metallic body 20, a metallic post 22 as a resonating structure, and a tuning screw 24. The tuning screw 24 (i.e., tuning disk) comprises a vertical portion 28 and a horizontal portion 30. As shown, the horizontal portion 30 extends down into the cavity 32 and is disposed above the resonating structure 22. A gap 26 is defined between a bottom surface of the horizontal portion 30 of the tuning screw 24 and an upper surface of the resonating structure 22. The capacitance of the resonator 12 generally correlates to the capacitance provided by the gap 26. The variable height of the gap 26 allows for continuously tunable operation.

In an embodiment, the tuning screw 24 may be manually rotated to drive the horizontal portion 30 upwardly to increase the size of the gap 26 or downwardly to decrease the size of the gap 26 in order to tune the center frequency of the filter 10. In another embodiment, the tuning screw 24 may be mechanically driven by, for example, a piezoelectric or mechanical motor, to drive the horizontal portion 30 upwardly to increase the size of the gap 26 or downwardly to decrease the size of the gap 26 in order to tune the center frequency of the filter 10. In another embodiment, the tuning screw 24 may be both manually and mechanically rotated to alter the size of the gap 26.

In an embodiment, the resonating structure 22 is a metal cylinder. In other embodiments, the resonating structure 22 may take other shapes and have other sizes in other embodiments. In an embodiment, the resonating structure 22 is formed from copper. The resonating structure 22 may be integrally formed with the body 20 of the resonator 12.

The body 20 may be formed in a variety of shapes (e.g., rectangular, square, cylindrical, polygonal, etc.) and from a variety of suitable materials such as, for example, copper. As shown, the body 20 of the tunable resonator 12 generally defines a metallic cavity 32. In an embodiment, the cavity 32 is three dimensional, which enables high power operation for base stations. In an embodiment, the body 20 of the tunable resonator 12, or some portion thereof, functions as a ground.

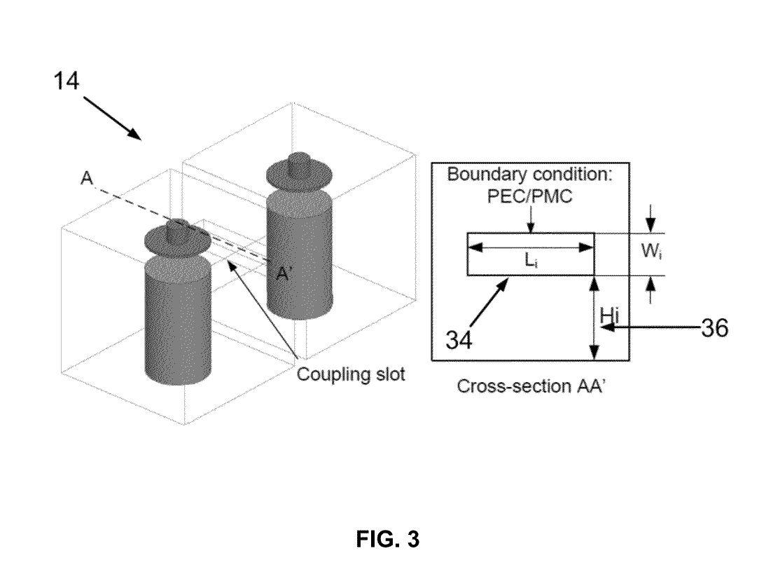

Referring now to FIG. 3, a cross section view of the coupling structure 14 used in the filter 10 of FIG. 1 is illustrated. The coupling structure 14 comprises of a horizontal slot 34. The height of the iris 34 from the bottom of the cavity 32 is variable. The magnitude of the electric coupling and magnetic coupling can be adjusted by the slot height (i.e., vertical position from the bottom of cavity) 36. Therefore, by optimizing the height of the horizontal slot 36, it is possible to obtain a balanced inter-resonator coupling to maintain the normalized coupling value constant when the center frequency of the filter 10 is tuned.

The inter-resonator coupling values are extracted from electromagnetic (EM) simulation of a pair of coupled resonators in FIG. 3. The coupled pair of resonators exhibit even and odd resonances fₑ and fₘ. The physical coupling coefficient is obtained as

$$k = \frac{{f}_{e}^{2} - {f}_{m}^{2}}{{f}_{e}^{2} + {f}_{m}^{2}}$$

and the normalized coupling value is

$$R = \frac{4}{2 π \cdot BW \cdot τ ( {f}_{o} )}$$

The disclosed design method in the present invention is based on using an EM optimization to find the optimum value of horizontal slot height 36 that results in a constant normalized coupling value M over the required tuning range of center frequency.

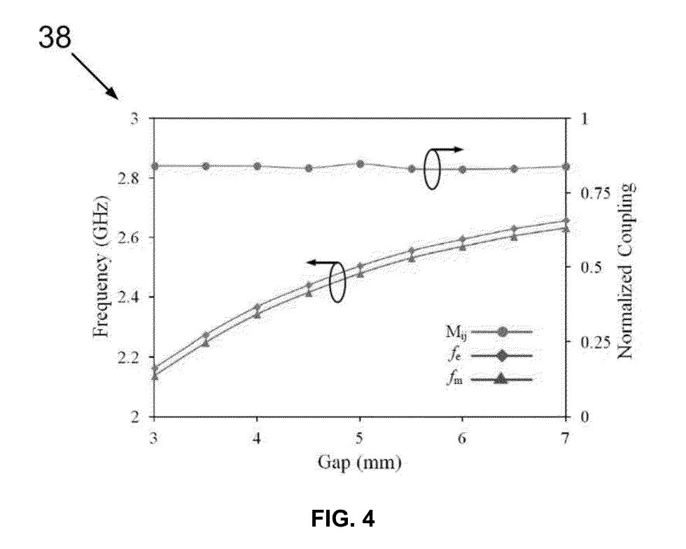

The simulated results for an optimum coupling slot height 36 (i.e., H=17.2 mm) are graphically illustrated in FIG. 4. As shown in the graph 38 of FIG. 4, a constant normalized coupling value is achieved for a tuning range from 2.15 GHz to 2.643 GHz (497 MHz tuning range) for this illustrative example.

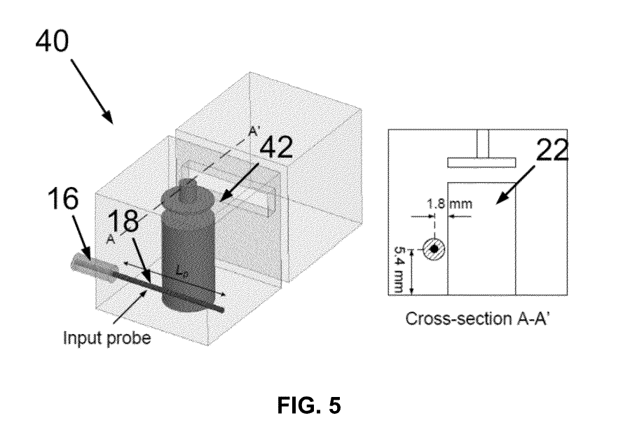

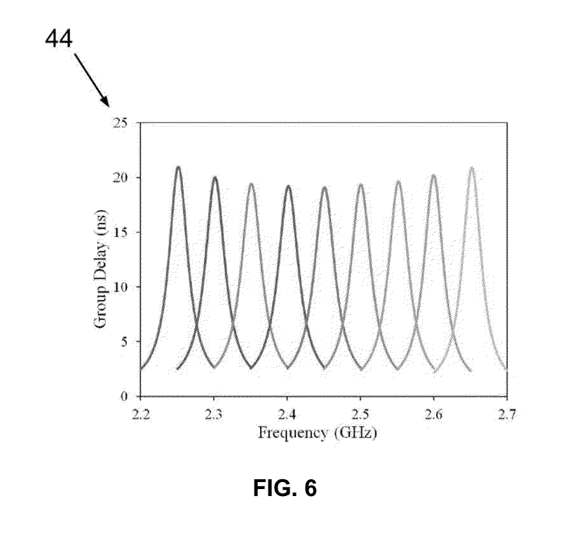

Referring now to FIG. 5, perspective and cross-section views of the input/output couplings of the filter 10 are shown. For a tunable bandpass filter, in order to have a constant absolute bandwidth, in addition to a constant normalized coupling between resonators, it is also required to have a constant normalized input impedance

$$M = \frac{{f}_{o}}{BW} k .$$

where τ(fₒ) is the group delay of the input/output reflection coefficients at the resonance frequency. In order to have a constant bandwidth, the maximum value of the group delay should be constant over the tuning range. The input/output coupling in FIG. 5 consists of an input probe 18 which is placed at an optimum height that maintains a constant group delay over the tuning range. The group delay is obtained using EM simulation of a first resonator 42 loaded with an input probe 18 as in FIG. 5. EM optimization is used to find the optimum value of the input/output probe length Lₚ that results in a relatively constant group delay value over the required tuning range of center frequency. The simulated group delay over a tuning range from 2.2 GHz to 2.7 GHz (500 MHz tuning range) for an optimum probe length of Lₚ=29.3 mm is graphically illustrated in FIG. 6.

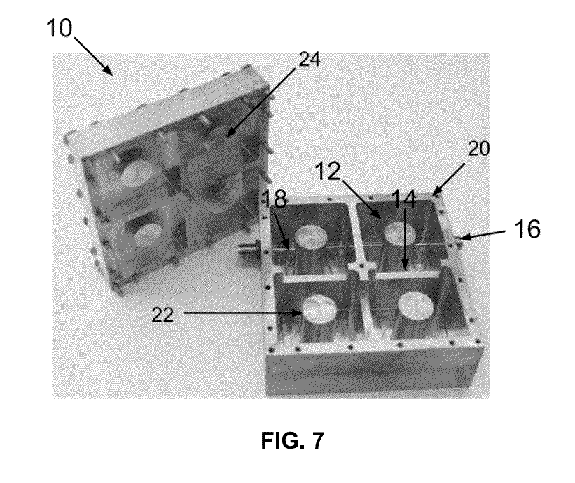

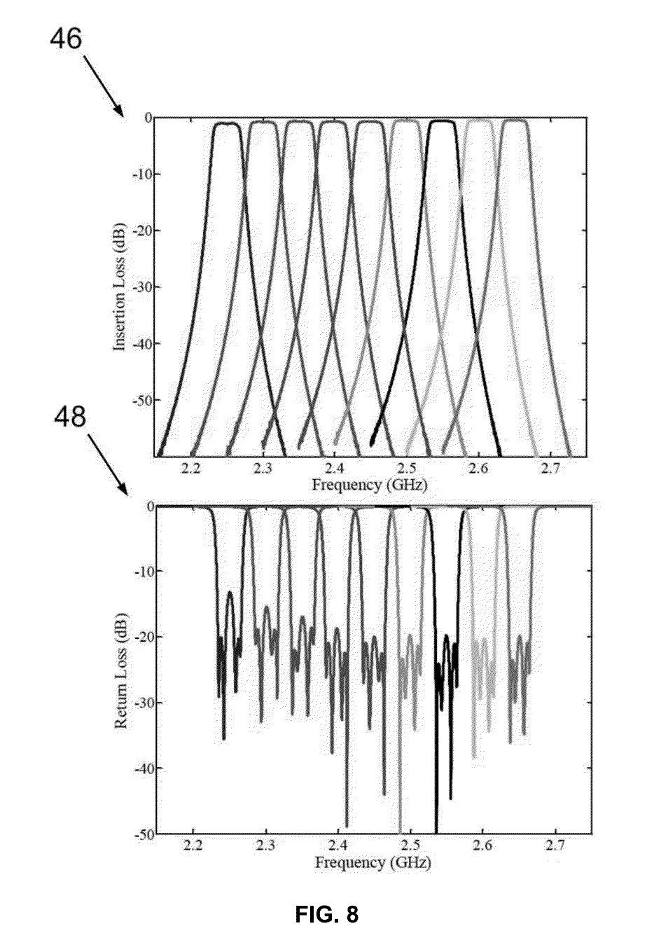

As proof of concept, one of the filters 10 was constructed as shown in FIG. 7. In particular, a four-pole filter 10 was constructed using four of tunable resonators 12 coupled as noted above. In that example, the resonators 12 were formed by machining copper (i.e., the resonator body 20 was copper). In this case, the tuning screw 24 is manually rotated to adjust the center frequency of the filter 10. The measured tuning response of the filter 10 is graphically illustrated in FIG. 8. As shown in the graph 46 of FIG. 8, the filter 10 provided a tuning range of approximately 400 MHz from about 2.25 GHz to about 2.65 GHz with an insertion loss better than 1.04 decibels (dB). The return loss as shown in the graph 48 of FIG. 8, was greater than about 15 dB for all the tuning states. The variation in the bandwidth is from 31.1 MHz to 28.9 MHz, less than ±3.7% over the entire tuning range.

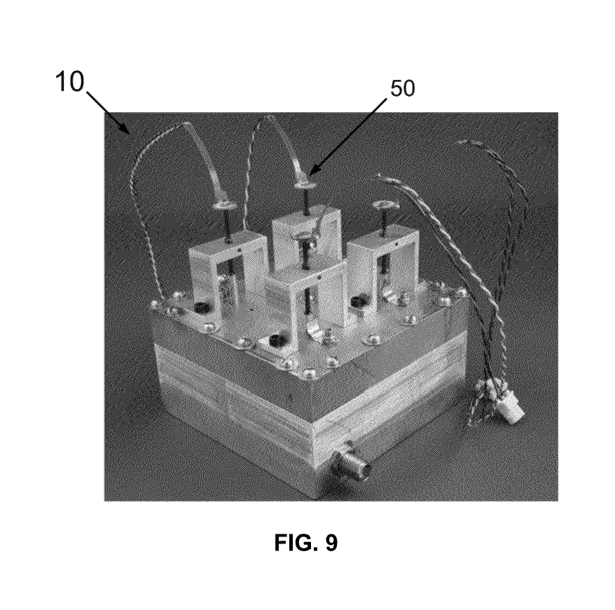

As further proof of concept, another embodiment of the filters 10 was constructed as shown in FIG. 9. In particular, a four-pole filter 10 was constructed using four of tunable resonators 12 where the tuning screws were mechanically driven by piezoelectric motors 50, to tune the center frequency of the filter 10.

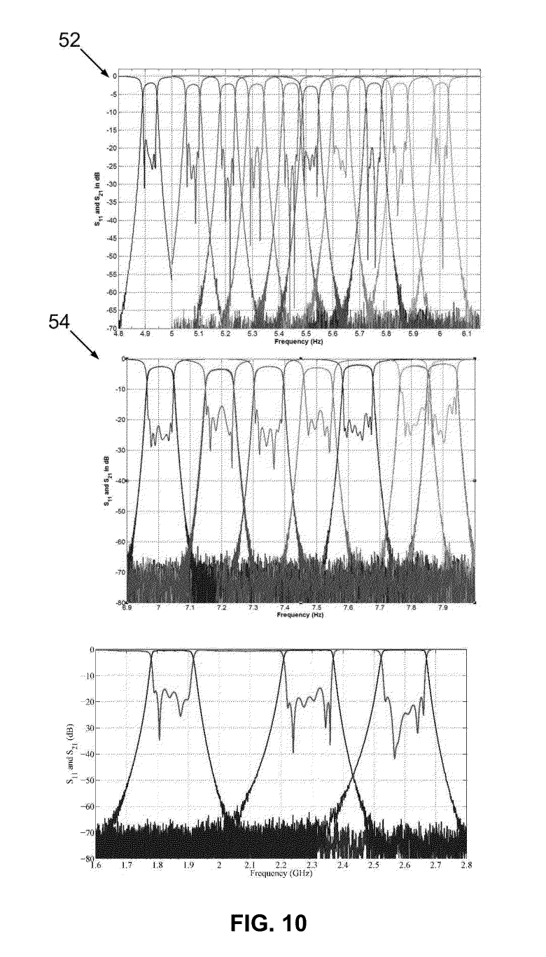

Further embodiments of the filters 10 are also constructed. In particular, five-pole and seven-pole filters are constructed using the disclosed design method. The measured tuning responses of these filters are graphically illustrated in FIG. 10. As shown in the graph 52 of FIG. 10, the five-pole filter provides a tuning range of approximately 1100 MHz from about 4.89 GHz to about 6 GHz. The return loss is greater than about 16 dB for all the tuning states. The variation in the bandwidth is from 44 MHz to 49 MHz, less than ±5.3% over the entire tuning range. As shown in the graph 54 of FIG. 10, the seven-pole filter provides a tuning range of approximately 898 MHz from about 7 GHz to about 7.898 GHz. The return loss is greater than about 14 dB for all the tuning states. The variation in the bandwidth is from 77 MHz to 88 MHz, less than ±6.7% over the entire tuning range. Another embodiment is also shown in FIG. 10 where a six-pole filter is built with a constant bandwidth over a tuning range from 1.8 GHz-2.6 GHz.

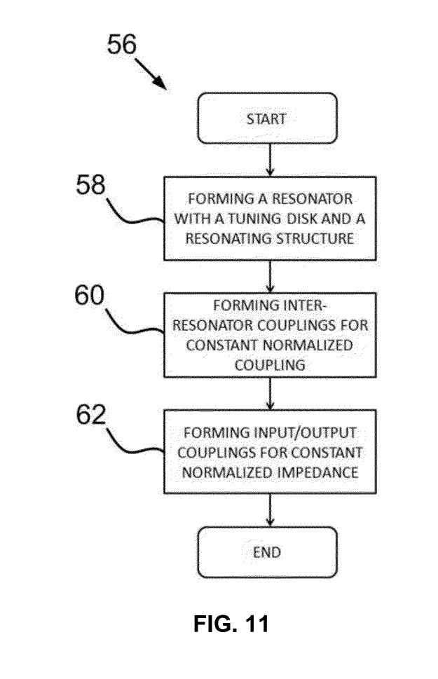

Referring now to FIG. 11, a method 56 of designing the filter is illustrated. In block 58, a resonator is formed with the tuning disk and the resonating structure. In block 60, the inter-resonator coupling structures are optimized for a normalized coupling value that remains constant over the tuning range of the filter. The optimization in block 60 is based on EM simulation for different values of the coupling slot height. In block 62, the input and output couplings of the filter are optimized to obtain a constant normalized input group delay over the tuning range. The optimization in block 62 is based on EM simulation for different lengths of the input/output probes.

Although embodiments described hereinabove operate within the specifications of a cellular communication network such as a 3GPP-LTE cellular network, other wireless communication arrangements are contemplated within the broad scope of an embodiment, including WiMAX, GSM, Wi-Fi, and other wireless communication systems, including different frequency, capacitance, and filter-type specifications.

While the disclosure has been made with reference to illustrative embodiments particularly the use of mechanical tuning such as screws and motors, this description is not intended to be construed in a limiting sense. The same concept can be also applied with the use of other mechanical tuning such as MEMS tuning elements or with the use of electrical tuning elements such as semiconductor BST or phase change materials type-tuning elements. Various modifications and combinations of the illustrative embodiments, as well as other embodiments, will be apparent to persons skilled in the art upon reference to the description. It is therefore intended that the appended claims encompass any such modifications or embodiments.

What is claimed is:

1. A tunable bandpass filter to provide a constant absolute bandwidth across a tuning range, said filter comprising:
a. a plurality of tunable resonators each said tunable resonator having a tuning element and a resonating structure;
b. a plurality of inter-resonator coupling structure to operably couple said plurality of tunable resonators to provide a balanced electromagnetic coupling with a constant normalized value, and
c. a plurality of input/output ports to connect said filter to a communication device, each said port having a probe, wherein said probe having a plurality of coupling parameters to provide constant input/output coupling values while said filter center frequency is tuned.

2. The tunable bandpass filter of claim 1, wherein said tuning element comprising of one or more mechanical screws, motors, MEMS, semiconductor, and Barium Strontium Titanate (BST).

3. The tunable bandpass filter of claim 1, wherein said resonating structure comprising of any one of cavity combline, dielectric resonator, waveguide, micromachined silicon, substrate integrated waveguide or any other known 3D resonator configuration.

4. The tunable bandpass filter of claim 1, wherein the inter-resonator coupling structure between said tunable resonators is in the form of coupling between adjacent resonators or non-adjacent resonators.

5. The tunable bandpass filter of claim 1, wherein said inter-resonator coupling structure is in the form of an iris or a coupling probe or a non-resonant node.

6. The tunable bandpass filter of claim 1, wherein said input/output coupling is in the form of a probe or an iris or a non-resonant node.

7. The tunable bandpass filter of claim 1, wherein each said inter-resonator coupling structure having a predefined dimensions and being located at a predefined height in the resonator, whereby the magnitude of an electric coupling and a magnetic coupling can be adjusted by said iris dimensions and height.

8. The tunable bandpass filter of claim 7, wherein said predefined dimensions and said predefined height of said coupling structure are determined by an electromagnetic simulation to obtain a constant absolute bandwidth for the entire designed range of the filter operating frequency.

9. The tunable bandpass filter of claim 7, wherein said inter-resonator coupling is a rectangular slot having a width and length, and said slot is located at a height inside the resonating structure, and wherein said width, length and height of said slot are optimized using EM simulation to obtain a constant absolute bandwidth for the entire designed range of the filter operating frequency.

10. The tunable bandpass filter of claim 1, wherein said coupling parameters being probe length and probe location inside the resonating structure.

11. A method of designing a tunable bandpass filter structures to obtain an absolute bandwidth that does not change over the entire tuning range of the filter, said method comprising of:
a. forming a plurality of tunable resonators, each resonator having a tuning element and a resonating structure;
b. forming a plurality of inter-resonator coupling structure between each pair of said tunable resonators, said coupling structure having a predefined dimensions and being located at a predefined location in between the resonators;
c. forming a plurality of input/output probes each having input/output coupling parameters;
d. forming a plurality of input/output ports to connect said filter to a communication device, and
e. determining the optimum values of said predetermined coupling dimensions and coupling location height, that results in a constant normalized coupling value over the required tuning range of center frequency.

12. The method of claim 11, wherein said input/output coupling values are determined by a probe length and a probe location inside said resonating structure.

13. The method claim 11, wherein the optimization of the input/output coupling parameter is based on electromagnetic optimization of said input/output probe length and probe location to obtain a constant peak group delay value over the tuning range of the filter.

14. A method of claim 11, wherein the input and output couplings of the filter are optimized to obtain a constant normalized input group delay over the tuning range.

15. The method of claim 11, wherein the electromagnetic optimization of the inter-resonator coupling element dimensions is performed to obtain a constant coupling value between the resonators over the tuning range of the filter.

16. The method of claim 11, wherein the coupling structure is a slot having a width and a length and being located at a height inside the resonating structure, and wherein said width, length and height of said slot are optimized to maintain the normalized coupling value constant when the center frequency of the filter is tuned by the height of the coupling slot.

17. A tunable bandpass filter to provide a constant absolute bandwidth across a tuning range, said filter comprising:
a. a plurality of tunable resonators, each said tunable resonator comprising:
i. an enclosure having a bottom surface, a top surface, an enclosure height and a plurality of walls to form a cavity;
ii. a resonating structure extending upwardly from said bottom surface of said enclosure, said resonating structure having an upper surface and a resonating structure height, said resonating structure is centrally installed inside said cavity;
iii. a tuning screw extending downwardly from the top surface, said screw having a flat head and an adjustable length, wherein said flat head is disposed above the upper surface of said resonating structure, wherein an adjustable-gap as a capacitance is defined between said flat head and said upper surface;
b. a plurality of coupling slots having a width and length to operably couple said plurality of tunable resonators to provide a balanced electromagnetic coupling with a constant normalized value;
c. a plurality of input/output ports to connect said filter to a wireless communication device, each said port having a probe to provide constant input/output coupling values while said filter center frequency is tuned;
d. each said probe having a probe-length and a probe-location, wherein said probe-location defines a probe-gap between said probe and said resonating structure,
e. said adjustable-gap, said width and length of said slot, said probe length and probe-gap are optimized to obtain a constant absolute bandwidth filter across a tuning range.
